(19) United States
(12) Patent Application Publication
(10) Pub. No.: US 2002/0143790 A1
(43) Pub. Date: Oct. 3, 2002

(54) Method and apparatus for automatic generation and management of sporting statistics

(76) Inventor: Richard J. Qian, Camas, WA (US)

Correspondence Address: PILLSBURY WINTHROP, LLP, P.O. BOX 10500, MCLEAN, VA, 22102, US

(21) Appl. No.: 09/821,319

(22) Filed: Mar. 29, 2001

(51) Int. Cl. G06F 17/30

(52) U.S. Cl. 707/104.1; 707/102

(57) ABSTRACT

A method of automatic statistics generation and management includes receiving input data of a sporting event. Semantic information and geometric model information is generated based on the input data. Sporting statistics is generated based on at least one of the semantic information and the geometric information.

### BACKGROUND OF THE INVENTION

1. Field of the Invention

The present invention generally relates to a system for creating and storing statistics. More particularly, the present invention relates to an automatic sporting statistics generation and management system requiring little or no human interaction to provide and maintain accurate results.

2. Discussion of the Related Art

Many sports leagues, such as the Federation Internationale de Football Association (FIFA), the National Basketball Association (NBA), the National Football League (NFL), and the National Hockey League (NHL), collect statistics from their games. In additional to sports leagues, many sports news service Web sites, such as ESPN and CNN/Sports Illustrated, as well as numerous sports-book wagering services, collect sporting statistics as well. Almost all of these statistics are currently collected by hand; that is, they are manually tracked and manually inputted by a human operator. However, manual input of statistical information is labor intensive and may be prone to human errors. Moreover, certain types of information about a sport, such as the running speed of a player, or the a trajectory of a ball in a given play, are difficult, if not impossible, to be readily collected by simply watching a game.

In addition to collecting sporting statistics for wagering purposes (e.g., calculating the “point spread”, the “over/under”, etc. for a game), sporting statistics are often kept for each player or team for the purposes of recruiting, negotiating salary contracts, or even determining awards for a league or conference (e.g., most valuable player, selection to the “Pro Bowl” or “All-Star Game”, etc.). In addition to the financially-motivated purposes of keeping statistics, many sports fans simply enjoy access to the statistics of their favorite player, team, etc. Furthermore, by having the ability to keep as much accurate and timely statistics as possible regarding a particular player, team, league, or sport, more information about the game is made available to the public, thus potentially increasing interest in a particular game, and therefore increasing the fan base.

### BRIEF DESCRIPTION OF THE DRAWINGS

FIG. 1 illustrates an automatic statistics generation and management system according to an embodiment of the present invention;

FIG. 2 illustrates sample types of soccer statistics that may be automatically generated by the automatic statistics generation and management system according to an embodiment of the present invention;

FIG. 3A illustrates a flow chart diagram of an operation of an automatic statistics generation and management system according to an embodiment of the present invention;

FIG. 3B illustrates a flow chart diagram of generating semantic information and geometric information according to an embodiment of the present invention; and

FIG. 3C illustrates a flow chart diagram of generating sporting statistics based on semantic information and geometric information according to an embodiment of the present invention.

### DETAILED DESCRIPTION

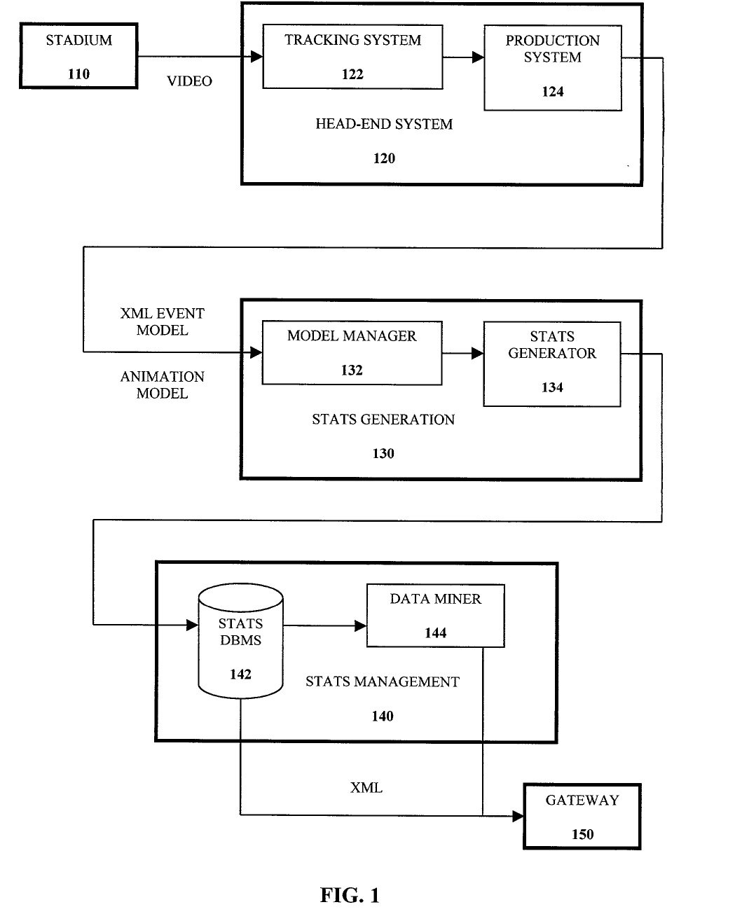

FIG. 1 illustrates an automatic statistics generation and management system according to an embodiment of the present invention. The automatic statistics generation and management system in FIG. 1 is adapted to automatically generate and manage statistics for sporting games. A head-end system 120 is provided to track the players and ball (or puck, etc.) in a sporting game. The head-end system 120 is adapted to receive input data of a sporting event and to generate semantic information and geometric information based on the input data.

The head-end system 120 preferably includes a tracking system 122 and a production system 124. The tracking system 122 is adapted to receive and process the input data to generate tracking information. The input data may include video provided from at least one video camera in a stadium 110 where the sporting event takes place. Preferably, a plurality of video cameras are utilized to capture the sporting game from different views, of which the input data video is provided to the head-end system 120. Therefore, the input data video may include numerous video footages from various video cameras located at different positions in the stadium 110. In addition to video, radio frequency (RF) beacons may be utilized to assist in obtaining the tracking information. RF beacons may be placed on the players, in the ball, puck, etc. to track their movement through the course of the sporting event via radio frequencies and RF receiver(s) at the stadium 110. Moreover, textual information relating to/describing the sporting event, such as from a closed-captioning simulcast, may also be provided as input data. The tracking system 122 processes the input data to determine the position of each player and the ball, puck, etc. The tracking system 122 may include a combination of frame (digitizing) “grabbers” and other software applications to capture frames of a video feed for analysis, to determine the locations of the RF beacons from the RF signals therefrom, and to interpret any textual information provided.

The tracking information is obtained by utilizing software applications that analyze the frames of the input data video, the RF signals, and textual information to identify each player, ball, puck, etc. in the stadium/field/court of play, and to track each element (player, ball, puck, etc.) throughout the course of the game. That is, the software applications are adapted to recognize each element of the game from the input data and track their course throughout the game. Imaging recognition algorithms may be implemented in these software applications to assist in identifying and tracking the elements of a game. For example, a software application utilizing image recognition algorithms may be able to analyze the input data video and identify a player based on the color of the jersey, the number on the jersey, the name printed on the jersey, the size of the player, the shape of the player, the player's face, etc., or any combination thereof. Moreover, a human operator may also be utilized to assist in identification and/or tracking of the elements of a game as well.

The tracking information is preferably a data file storing primarily numeric values corresponding to x, y, z coordinate information for each element (player, ball, puck, etc.) of the game within the stadium/field/court of play 110. The coordinate information for each element of the game is preferably stored on a frame-by-frame basis, such as by time codes. The x, y, z coordinate information for each element of the game may be relative to the stadium/field/court of play 110. The tracking information may be a static file, or a streaming file, generated in real-time as the game is progressing.

The production system 124 receives the tracking information from the tracking system 122 and generates the event model (semantic) information and the animation model (geometric) information. The event model information is preferably in the Extended Markup Language (XML) format, or another suitable format. XML is a mark-up language developed by the World Wide Web Consortium (W3C) that is a simplified version of Standard Generalized Markup Language (SGML), which allows Web developers to create customized tags that organize and deliver content efficiently.

The production system 124 utilizes software algorithms to automatically detect and add events and actions/motions to the event model information and the animation model information based on the tracking information provided by the tracking system 122. That is, the software applications of the production system 124 contain the rules and specifics of a particular sporting game so that it determines from the tracking information all the statistical information that is to be recorded for the game, including player actions, team actions, event occurrences, plays executed, points scored, penalties, etc. In other words, the production system 124 is adapted to account for all the details of a game based only on the tracking information provided thereto. A human production operator also may be able to view the event model information and the animation model information, and insert or edit the events and motions, if necessary, to provide greater accuracy and flexibility for the entire system.

The event model information, derived from the tracking information, preferably contains higher-level semantic information describing game-rule type events that occur during a game. For example, a soccer game is essentially constituted of a series of player actions and player-ball or player-player interactions. Some of these actions or interactions lead to certain consequences, e.g., a goal or a yellow card, as determined by the soccer rules. In general, certain types of actions or interactions may be considered as semantically significant in the meaning of the game, e.g., a corner-kick, while others may be considered as simple physical motion, e.g., running. The event model information emphasizes the description of the semantically significant actions, interactions, and consequences, which may be universally called “events”. Events such as a committed foul, a player kicking a ball, performing a corner kick, scoring a goal, an interception, along with the time of occurrence for each event and the player(s) involved, are examples of semantic information that may be included with the event model information. As discussed above, the event model information is preferably stored as an XML document so as to enable XML queries to be performed.

The animation model information, derived from the tracking information, preferably contains information on the actions and motions of the elements (players, ball, puck, etc.) of the game. The animation model information is at a higher level than, and also includes, the x, y, z coordinate information of the tracking information (i.e., the animation model information is a superset of the x, y, z, coordinate information). But, the animation model information is at a lower level than the semantic information found in the event model information. For example, the information concerning the actions and motions of the elements of the game, also known as geometric information, may include: a player kicking a ball, a player running without a ball, a player moving from one side of the field to another, the movement of a ball, the movement of a player (e.g., speed and direction), etc. The event model information and the animation model information may include the same information, though (i.e., there is some overlap between the two types of information). However, the animation model information typically includes lower-level data, e.g., geometric information (movement, direction, speed, etc.), such as the motions and actions performed to execute a play. On the other hand, event model information generally includes higher-level semantic information, such as describing an executed play itself, rather than the actions and motions that make up the play (as would be typically described by the animation model information).

A statistics generation system 130 receives the event model information and the animation model information from the head-end system 120 and generates the sporting statistics. The statistics generation system 130 preferably includes a model manager 132 and a statistics generator 134. The model manager 132 allows access to the semantic and geometric information in the event model information and the animation model information, respectively. More specifically, the model manager 132 reads the semantic information from the event model information and the geometric information from the animation model information.

The statistics generator 134 receives and processes the semantic and geometric information received from the model manager 132 to generate the sporting statistics. Based on the particular rules of a sporting game, preferably incorporated into software algorithms within the statistics generator 134, sporting statistics such as the number of goals scored, the number of yards rushed, the number of interceptions made, etc., may be determined from the semantic and geometric information. The sporting statistics are preferably stored as an XML document or file corresponding to, for example, a predetermined XML Schema Definition Language (“XML Schema Part 1: Structures” and “XML Schema Part 2: Datatypes”, World Wide Web Consortium (W3C) Working Draft, Apr. 7, 2000) for describing sporting statistics. The sporting statistics schema defines a common structure and terms used in the XML statistics file so that these documents can be easily consumed by other query and data mining programs. In other words, the schema is adapted to describe a particular sporting game and its components (e.g., players, ball, puck, etc.) in a particular format that is easily accessible via XML query applications.

A statistics management system 140 receives and stores the generated sporting statistics and is also adapted to analyze the sporting statistics. The statistics management system 140 collects sporting statistics from a plurality of games and organizes the data to support query and data mining functions. The sporting statistics are preferably presented to the statistics management system 140 in the form of XML documents, generated based on the predefined sporting statistics XML schema, discussed above. The statistics management system 140 preferably includes a statistics database 142 and a data miner 144.

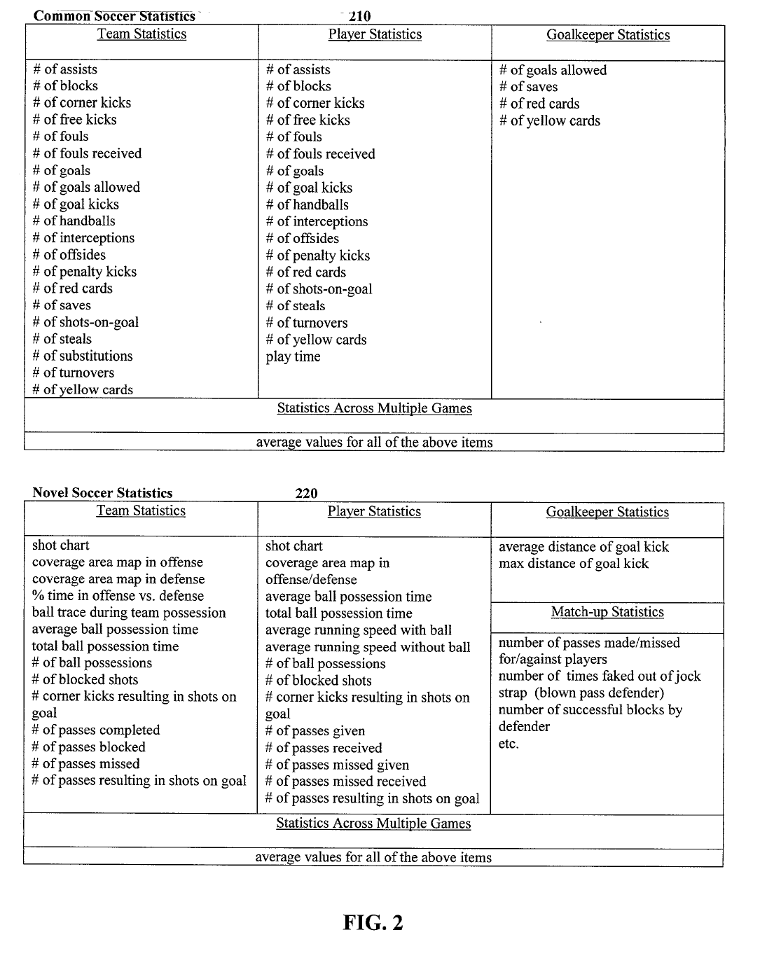

The statistics database 142 may be a database management system (DBMS) that enables one to store, modify, and extract information from a database. The statistics database 142 creates and manages a database for storing and organizing the sporting statistics, such as in the predefined sporting statistics XML schema. FIG. 2 illustrates some common 210 and novel 220 sporting statistics for a soccer game that may be automatically generated using the automatic statistics generation and management system according to an embodiment of the present invention. Some common statistics 210 include the number of goals scored, the number of red cards issued, and the number of penalty kicks performed. Some novel soccer statistics 220 include a graphical shot chart of the goals scored during a game, the average ball possession times for each team, player, etc., and the average or maximum distances of the goals scored during the game. Each of these types of statistics may be stored in the statistics database 142 for each game of a season, and for a plurality of seasons. The statistics database 142 may be based on XML and support XML query operations. Query operations utilizing XML, for example, allow for rapid retrieval of statistics based on any criteria, including individual statistics, team statistics, league statistics, and specialized statistics (e.g., percentage of time a player spends on offense v. defense, average distance of a goal kick for a player in a particular season, etc.). Query operations may include any number of different criteria to search for particular statistics. The statistics database 142 may have a connection to a gateway 150, such as a Web-based user interface, to support query applications from a remote user. The statistics database 142 may also provide data to the data miner 144 to perform additional analysis.

The data miner 144 is adapted to extract and analyze the sporting statistics data stored in the statistics database 142. For example, the data miner 144 may include algorithms to analyze the data to discover patterns and predict future trends of players, teams, etc. The data miner 144, too, may include a connection to a gateway 150, to support query applications. That is, for statistical information requiring additional calculations to obtain, the data miner 144 is adapted to search through the statistics database 142 to obtain the necessary information and analyze and compile the statistics information to be presented to a user.

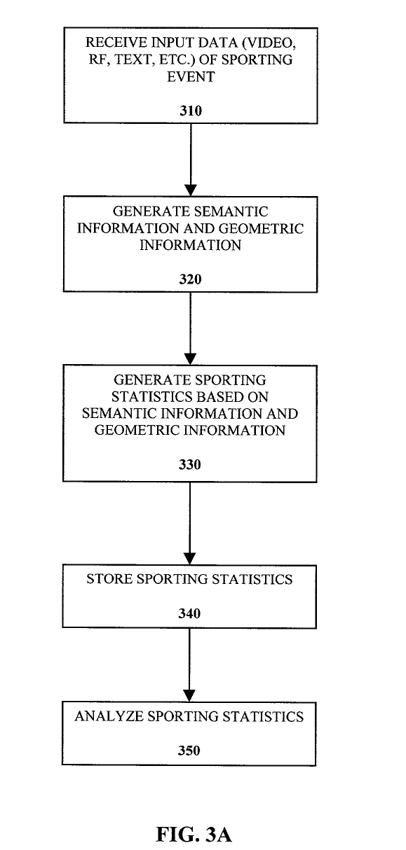

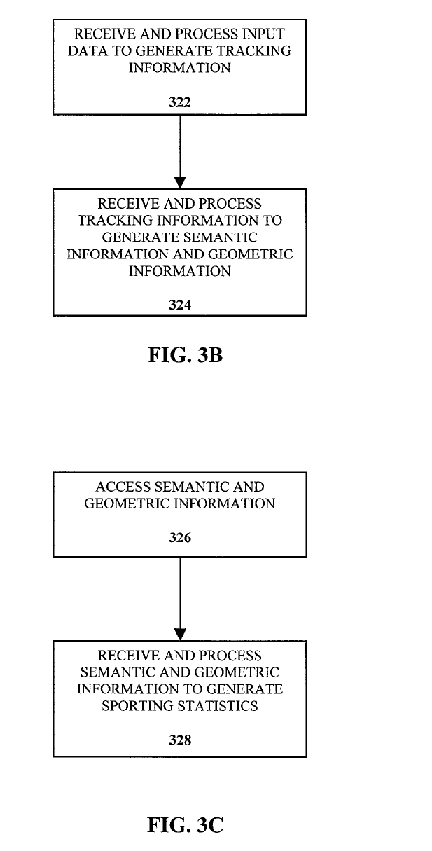

FIG. 3A illustrates a flow chart diagram of an operation of an automatic statistics generation and management system according to an embodiment of the present invention. The head-end system 120 of the automatic statistics generation and management system receives 310 input data of a sporting event. Semantic information and geometric information is generated 320 at the head-end system 120 based on the input data.

FIG. 3B illustrates a flow chart diagram of generating semantic information and geometric information according to an embodiment of the present invention. The input data is received and processed 322 to generate the tracking information. The tracking information is received and processed 324 to generate the semantic information and the geometric information. Video tracking hardware and software algorithms may be utilized to track the elements of a sporting event, such as those by Sport Universal (France), which develops software applications for tracking soccer players. When combined with RF-based tracking systems, such as those developed by Trakus (U.S.A.) for tracking objects in hockey games, along with textual information about the sporting event, the tracking information that is obtained may be more accurate.

By analyzing the tracking information, which preferably is correlated with a time stamp, events and actions may be detected. For example, a ball in a sporting event may be tracked and its tracking information obtained—e.g., its location, velocity, and direction of travel. When the location of the ball coincides with that of a player, and the ball abruptly changes velocity, direction of travel, etc., it may be inferred that the ball was engaged by the player, such as with a kick. Algorithms relating to the rules of a particular sporting game are provided to interpret the tracking information and determine whether the ball was kicked by a player, or some other action. In another example, when tracking a ball, and its tracking information indicates that it has entered the location of the stadium where a net (or goal post, end zone, etc.) resides, it may be determined that a player has scored a goal.

Referring back to FIG. 3A, the statistics generation system 130 generates 330 sporting statistics based on at least one of the semantic information and the geometric information received from the head-end system 120. Some statistics may be generated solely based on the information provided by semantic information (e.g., the number of goals scored in a game, the number of red-cards in a game), while some statistics may be generated solely based on geometric information (e.g., the maximum running speed of a player in a game, the average running speed of a player in a game).

FIG. 3C illustrates a flow chart diagram of generating sporting statistics based on semantic information and geometric information according to an embodiment of the present invention. Semantic and geometric information is accessed 326, preferably from the statistics generation system 130. The semantic and geometric information is received and processed 328 to generate the sporting statistics. For example, the statistics of how many goals were scored in a game may be obtained by accessing the semantic information and counting the number of goals events recorded. To determine a statistical shot chart, for example, the semantic information may be accessed to determine when each goal event occurred, and then accessing the geometric information to determine the locations of where each goal event occurred based on the time of each goal event occurrence. An appropriate graphic visually depicting a “shot chart” relative to the stadium may be prepared based on this information extracted from the semantic and geometric information. Other more complex statistics, such as performance of individual players matched up with other particular players (e.g., Dr. J vs. Larry Bird), may be calculated as well by processing the semantic and geometric information obtained from the event model information and the animation model information, even if it is only for a particular game, up to a season, or a series of seasons.

Referring back to FIG. 3A, once the sporting statistics have been generated 330 by the statistics generation system 130, they are preferably stored 340 by the statistics management system 140 in a database 142. The sporting statistics may be analyzed 350 to produce additional data, predictions, trends, etc.

The head-end system 120, the statistics generation system 130, and the statistics management system 140 may reside within a single computer system or server, or, each may be comprised of a number of computer systems. The components of the head-end system 120 (the tracking system 122 and the production system 124), the statistics generation system 130 (the model manager 132 and the statistics generator 134), and the statistics management system 140 (the statistics database 142 and the data miner 144) may reside within a single computer system or server, or each may be comprised of a number of computer systems as well. Additionally, the head-end system 120, the statistics generation system 130, and the statistics management system 140, and the components thereof, may be remotely located from each other and distributed across a network, for example, such as the Internet. Preferably, the automatic statistics generation and management system is located at the stadium 110 itself, but, each of its components may be remotely-located and connected together via network connections.

Accordingly, by automating the generation and management of sporting statistics, sporting statistics may be provided faster and more accurately than using human technicians alone. Moreover, the flexibility of the automatic statistics generation and management system allows sporting statistics to be updated in real-time as a game is progressing, providing the most up-to-date and accurate statistics available.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A method of automatic statistics generation and management, comprising:
receiving input data of a sporting event;
generating semantic information and geometric model information based on the input data; and
generating sporting statistics based on at least one of the semantic information and the geometric information.

2. The method according to claim 1, further including storing the sporting statistics.

3. The method according to claim 1, further including analyzing the sporting statistics.

4. The method according to claim 1, further including providing the input data from at least one video camera located at the sporting event.

5. The method according to claim 1, further including receiving a query for the sporting statistics.

6. The method according to claim 1, further including:
processing the input data to generate tracking information; and
processing the tracking information to generate the semantic information and the geometric information.

7. The method according to claim 1, further including analyzing the sporting statistics to discover patterns and predict future trends.

8. The method according to claim 1, wherein the input data is video.

9. The method according to claim 1, wherein the input data is from a radio frequency (RF) beacon.

10. The method according to claim 1, wherein the input data is textual information.

11. An automatic statistics generation and management system, comprising:
a head-end system to receive input data of a sporting event and to generate semantic information and geometric information;
a statistics generation system to generate sporting statistics based on at least one of the semantic information and the geometric information received from the head-end system; and
a statistics management system to store and manage the sporting statistics received from the statistics generation system.

12. The system according to claim 11, further including at least one video camera, located at the sporting event, to provide the input data to the head-end system.

13. The system according to claim 11, further including a gateway connected to the statistics management system to support query applications from a user interface.

14. The system according to claim 11, wherein the head-end system includes:
a tracking system to receive and process the input data to generate tracking information; and
a production system to receive and process the tracking information to generate the semantic information and the geometric information.

15. The system according to claim 11, wherein the statistics generation system includes:
a model manager to access the semantic information and the geometric information; and
a statistics generator to receive and process at least one of the semantic and geometric information from the model manager to generate the sporting statistics.

16. The system according to claim 11, wherein the statistics management system includes:
a statistics database to store and manage the sporting statistics; and
a data miner to extract and analyze the sporting statistics stored in the statistics database.

17. The system according to claim 16, wherein the data miner analyzes the sporting statistics to discover patterns and predict future trends.

18. The system according to claim 11, wherein the semantic information is an Extended Markup Language (XML) file.

19. The system according to claim 11, wherein the sporting statistics are saved in a predefined Extended Markup Language (XML) schema.

20. The system according to claim 11, wherein the input data is video.

21. The system according to claim 11, wherein the input data is from a radio frequency (RF) beacon.

22. The system according to claim 11, wherein the input data is textual information.

23. An automatic statistics generation and management system, comprising:
a head-end system including a tracking system to receive and process input data of a sporting event to generate tracking information, and a production system to receive and process the tracking information to generate semantic information and geometric information;
a statistics generation system including a model manager to receive and access the semantic information and the geometric information, and a statistics generator to receive and process at least one of the semantic information and the geometric information to generate sporting statistics; and
a statistics management system having a statistics database to store and manage the sporting statistics, and a data miner to extract and analyze the sporting statistics stored in the statistics database.

24. The system according to claim 23, further including at least one video camera, located at the sporting event, to provide the input data to the head-end system.

25. The system according to claim 23, further including a gateway connected to the statistics management system to support query applications from a user interface.

26. The system according to claim 23, wherein the data miner analyzes the sporting statistics to discover patterns and predict future trends.

27. The system according to claim 23, wherein the input data is video.

28. The system according to claim 23, wherein the input data is from a radio frequency (RF) beacon.

29. The system according to claim 23, wherein the input data is textual information.

30. The system according to claim 23, wherein the sporting statistics are saved in a predefined Extended Markup Language (XML) schema.
